(19) United States
(12) Patent Application Publication
(10) Pub. No.: US 2005/0087621 A1
(43) Pub. Date: Apr. 28, 2005

(54) Injection device for internal combustion engines comprising a control valve and a valve for controlling the supply of fuel to an injection device

(76) Inventors: Andrej Astachow, Regensburg (DE); Johann Warga, Bietigheim-Bissingen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 10/961,327

(22) Filed: Oct. 8, 2004

Related U.S. Application Data
(63) Continuation of application No. PCT/DE03/01071, filed on Apr. 1, 2003.

(30) Foreign Application Priority Data
Apr. 11, 2002 (DE) 10215981.5

(51) Int. Cl. F02M 47/02

(52) U.S. Cl. 239/88

(57) ABSTRACT

A known control valve, especially for controlling a piston of a pressure intensifier of an injection device for internal combustion engines is already known per se. Said control valve comprises a control valve housing, fluid lines and a control valve piston which can be displaced in a controlled manner in the housing in at least two operational positions. Said piston controls at least the fluidic connection between a first chamber and a second chamber having a first flow rate or a reduced second flow rate. In order to produce said control valve which enables the precise control of the reduced second flow rate and which is simple to construct, a throttle is provided. Said throttle adjusts the reduced second flow rate and is arranged outside the control valve piston and in front of the second chamber.

### CROSS-REFERENCE TO RELATED APPLICATION OR PRIORITY

This application is a continuation of co-pending International Application No. PCT/DE03/01071 filed Apr. 1, 2003 which designates the United States, and claims priority to German application number DE10215981.5 filed Apr. 11, 2002.

### FIELD OF THE INVENTION

The present invention relates to an injection device for internal combustion engines and a valve for controlling the supply of fuel to an injection device.

### BACKGROUND OF THE INVENTION

A control valve is known from U.S. Pat. No. 5,460,329, wherein a working medium controls a pressure intensifier by means of moving the control valve piston. On the other hand, the movement of the pressure intensifier piston correspondingly controls the movement of a valve needle in an injection valve for a fuel injection process. The control valve piston thus comprises control edges by means of which the flow of the working medium is controlled using the control valve.

Furthermore DE 196 49 833 discloses an electrohydraulic control device comprising two adjustment devices by means of which the overlapping of the control edges of the control piston can be adjusted for two volume flows and thereby their characteristic curves. In this way the interfering influence of tolerances of the control edges are compensated for.

DE 199 99 771 discloses a switch valve of a hydraulic drive for a switching device in particular, whereby three different lines can be controlled in connection with one another or separately from one another by means of a control piston. In spite of the weak performance design of the electromagnetic systems implemented, the effected switches are extremely dynamic and the exact repetition accuracy of the proper time can be effected without any problem. In this way a second end of the control piston is located in a pressure chamber, which can be connected by means of a line to the tank line. In the event of the switch-off process of the switching device, the pressure chamber is subjected to high pressure, which results in the control movement of the control piston. The high pressure in the pressure chamber reduces again after the electromagnet system is turned off by means of a throttle provided in the line.

### SUMMARY OF THE INVENTION

The object of the present invention is to provide a control valve, which enables the precise control of a reduced flow rate with a simple structure.

In accordance with the invention, this is achieved with a control valve having the features: a control valve having a housing with fluid lines and a control valve piston, said control valve piston displaceable in at least two operating positions, said piston controlling at least the fluid connection between a first chamber and a second chamber with a first flow rate or a reduced second flow rate, wherein a throttle is arranged outside the control valve piston in front of the second chamber in order to set the reduced second flow rate.

With the proposed solution, a control edge or throttle edge embodied on the moveable control valve piston itself can be dispensed with, thus simplifying the construction and manufacture of the control valve. In accordance with the invention, a throttle is arranged outside the control valve piston and in front of the second chamber, in order to set the reduced second flow rate. The accuracy of the fluid dose is increased during its supply to the second chamber and to the pressure intensifier by implementing the throttling at a defined position without moveable parts. The object of the control piston drive for guaranteeing the smallest injection amount is achieved in a simple manner and with a high-level of accuracy. Instead of a fluid throttling in the gap between the control piston and the control valve housing, a throttling is proposed through the narrowing of the channel cross section behind the valve.

The throttle is advantageously arranged in one of the fluid lines of the control valve housing between the control valve piston and the second chamber. The medium is also pumped into the volume between the throttle and the control piston when the system is filled. The larger the volume selected, the more time is lost in the system required to fill this volume. These losses are then minimized if the throttle is arranged as close as possible to the control valve piston.

According to a preferred embodiment provision is made for a throttle to be embodied as a separate part and to be installed in the fluid line. The manufacturing technology involved in the exact production of the throttle opening is thus substantially simplified in comparison with embodying the throttle directly in the fluid canal. On the other hand, fitting the throttle manufactured as a separate part outside the valve housing requires an additional installation step.

Two exemplary embodiments of the control valve according to the invention are described below.

### BRIEF DESCRIPTION OF THE DRAWINGS

FIG. 1 shows a schematic side view of the control valve according to the invention in three operational positions in accordance with the first exemplary embodiment as well as the flow scheme.

FIGS. 2a and 2b show detailed control valve on an enlarged scale according to the first and the second exemplary embodiments.

### DETAILED DESCRIPTION OF THE PREFERRED EMBODIMENTS

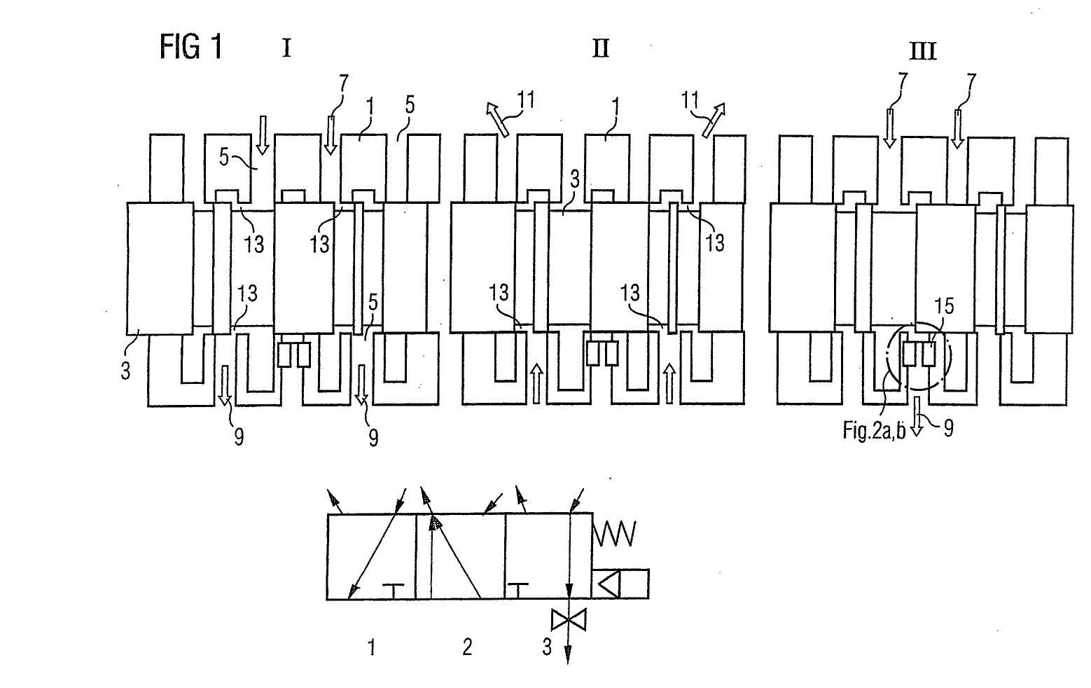

A three-way control valve for controlling a piston in the pressure intensifier of an injection valve for internal combustion engines (not shown) comprises a control valve piston 3 arranged in a control valve housing 1. The axial position in the valve housing 1 is controlled by a known control device (not shown). Different radial fluid lines 5 are embodied in the control valve housing 1 by means of bores. A rail 7, a pressure intensifier 9 and a distributing canal 11 can be controlled by means of these, in connection with one another. In accordance with FIG. 1, the three-way control valve comprises three operating positions or positioning options for the control valve piston 3 (I, II, III). In position I the valve connects the fluid supply from the rail 7 to the pressure intensifier 9 by means of two flow paths with a first flow rate D1. This is also determined by means of the free opening cross-section between the control piston 3 and the corresponding control edges and the respective entrance opening of the fluid lines 5. In position II the valve and the control valve piston 3 separate on the one hand the supply of the fluid to the pressure intensifier 9, whereby the corresponding opening is closed. On the other hand, the control valve connects the chamber of the pressure intensifier 9 with the discharge chamber 11, in an opposite flow direction by means of two flow paths. The control piston 3 comprises numerous corresponding ring grooves (13) for the fluid control, which form the control edges of the control valve piston 3. Finally in position III, the valve closes the opened flow cross-section in positions I and II and effects the fluid supply from the rail 7 to the middle channel 5 and to the pressure intensifier (9). In a similar manner to other fluid channels, this fluid channel typically has a diameter of approximately 2 mm and a length of approximately 10 mm. In this way a throttle 15 is arranged in the middle fluid channel 5 of the pressure interpreter 9 in direct proximity to the control valve piston 3, which in contrast to the two other operating positions (I, II) selectively reduces the fluid flow to a reduced second flow rate D2 in comparison with the first flow rate D1. This flow rate D2 is not set by means of corresponding control edges of the control piston 3. The symmetrical structure of the control valve and the symmetrical arrangement of the throttle 15 in the valve housing 1 avoid the possibility that axial forces effect the control valve piston 3, which must be additionally compensated for. FIG. 1 shows the schematic diagram of the valve in order to illustrate the principle.

In position III of the valve, the drive of the hydraulic pressure intensifier 9 is not implemented using full force as in position I, but only with partial force. Subsequently a piston of the pressure intensifier 9 in position III of the control valve moves more slowly than in position 1. The use of the throttle also results in a reduction of the volume flow of the medium for the pressure intensifier and thus an increase in the time required by the working medium to the pressure intensifier. The pressure produced by the pressure intensifier piston in the high-pressure chamber of the pressure intensifier 9 is just sufficient to temporarily open an injector needle into a pressure controlled injection nozzle in an injection device having an electromagnetically controlled hydraulic circuit and not using the complete needle stroke (not shown). This results in minimal fuel quantity being injected in position III. The pressure on the injection nozzles thus increases more slowly and together with the switching times specified, comparatively less full is injected. The difference in filling times caused by the throttle is thus indicated simplified by a factor of around 4. The supply of the working medium to the pressure intensifier is thus purposefully throttled in position III of the control valve, in order to achieve the desired movement of the pressure intensifier piston and thereby a stable, temporary opening of the injection nozzles for the smallest possible injection quantity.

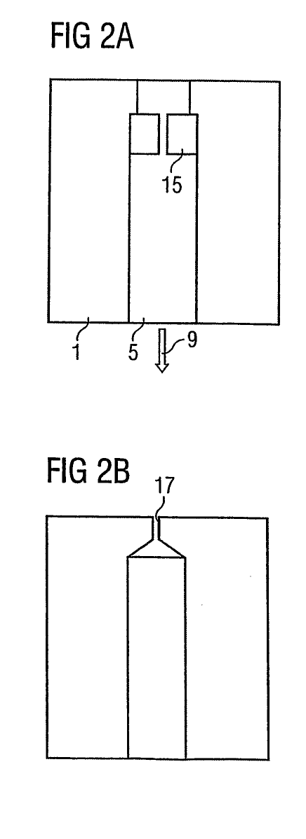

FIGS. 2a and 2b show enlarged diagrams comparing the throttle 15 according to the first exemplary embodiment with an alternative throttle 17 according to a second exemplary embodiment. In accordance with FIG. 2a, the throttle is formed by a ring, which is impressed into the fluid channel 5 after the manufacture of the throttle core. The throttle is thus made from the same material as the control valve housing 1. FIG. 2b shows the throttle embodied directly in the inner wall of the fluid channel 5. In this embodiment the throttle can be bored or eroded and if necessary can be subsequently rounded to the set value of the reduced hydraulic flow rate D2.

1. An injection system for controlling a piston of a pressure intensifier of an injection device for an internal combustion engine, said system comprising:
a control valve having a housing with fluid lines and a control valve piston, said control valve piston displaceable in at least two operating positions, said piston controlling at least the fluid connection between a first chamber and a second chamber with a first flow rate or a reduced second flow rate, wherein a throttle is arranged outside the control valve piston in front of the second chamber in order to set the reduced second flow rate.

2. An injection system according to claim 1, wherein the throttle is arranged in one of the fluid lines of the control valve housing between the control valve piston and the second chamber.

3. An injection system according to claim 2, wherein the throttle is arranged in one of the fluid lines of the control valve housing slightly distanced from the control valve piston.

4. An injection system according to claim 1, wherein the throttle is embodied as a separate part.

5. An injection system according to claim 1, wherein the throttle is molded in one of the fluid lines.

6. An injection system according to claim 1, wherein the control valve piston comprises at least one control edge for setting the first flow rate.
